(19) United States
(12) Patent Application Publication
(10) Pub. No.: US 2012/0020682 A1
(43) Pub. Date: Jan. 26, 2012

(54) IMAGE FORMING APPARATUS AND MANAGEMENT METHOD EMPLOYED BY IMAGE FORMING APPARATUS

(75) Inventor: Takemasa IKEDA, Tokyo (JP)

(73) Assignee: KONICA MINOLTA BUSINESS TECHNOLOGIES, INC., Tokyo (JP)

(21) Appl. No.: 13/185,355

(22) Filed: Jul. 18, 2011

(30) Foreign Application Priority Data
Jul. 23, 2010 (JP) JP2010-165983

(51) Int. Cl. G03G 15/00

(52) U.S. Cl. 399/24; 399/81

(57) ABSTRACT

An image forming apparatus including a plurality of replaceable parts and a control section which manages an accumulated amount of work of each of the parts; wherein the control section comprises reference values for replacement of each of the parts and performs, a first mode which carries out a prescribed control in case where an accumulated amount of work of any one of parts of the plurality of parts reaches one of the reference values for replacement; and, a second mode which carries out the prescribed control in case where an accumulated amount of work of a specific part of the plurality of parts reaches one of the reference values for replacement.

### RELATED APPLICATION

The present application is based on Patent Application No. 2010-165983 filed at the Japan Patent Office on Jul. 23, 2010 and which is hereby incorporated herein in its entirety.

### TECHNICAL FIELD

The present invention relates to an image forming apparatus and a management method employed by an image forming apparatus which carries out image formation based on image data, and in particular, to an image forming apparatus and management method which, based on replacement criteria, controls replaceable parts which composes the apparatus.

### BACKGROUND

In the image forming apparatus of an electrophotographic system, an electrostatic latent image is formed on an image bearing body such as a photoreceptor drum by a writing unit using laser light, and then, the electrostatic latent image is developed using toner accommodated in a toner bottle, which developed image is then transferred directly or through a transfer belt and the like onto a sheet of paper fed from a sheet feeding roller. After that, pressing and heating are carried out at a fixing device to fix the toner on the sheet of paper.

The photoreceptor drum, sheet feeding roller, writing unit, toner bottle, fixing unit, and the like, which were described above, are parts in which their lives are almost determined by the number of use, and therefore, by making these parts replaceable and carrying out their replacement works at proper time, it is possible to maintain excellent image quality. A technology has been known in which the accumulated amount of work of replaceable parts used in an apparatus is managed to allow the replacement to be done at proper time, and at the same time, when the accumulated amount of work of any one of parts arrives at a prescribed reference value, a “warning display” is carried out to inform the user that replacement of the aforesaid part is required.

When the user confirms the warning display, the user makes contact with a service person such as a customer engineer and asks for the replacement work of the part, but during the service person is replacing the part, downtime when the apparatus cannot be used is generated, and at the same time, expenses for the parts replacement are also caused.

However, for example, at a location where the apparatus is set up where very high image quality of a document or the like which is an output of image formation is not essential, some parts can be continued to be used if the image quality has no problem even if the part has reached the above-described end of life, and such part does not always require a warning that the part has reached the end of life. Therefore, in Japanese Patent Application Publication No. H08-63053, a technology has been disclosed in which inconvenience that preliminary warnings take place one after another can be removed by allowing the user being able to appropriately select a display or non-display of preliminary warning to inform of reaching the end of life of a drum unit.

Incidentally, while there are some parts which can be continued to be used even if they come to the end of their lives, there are some parts which cannot be functionally used over their lives. For such parts, it is necessary to certainly carry out a warning at a stage when the accumulated amount of work exceeds a reference value. In this way, when a warning to urge parts replacement is carried out, a warning is desirably carried out in response to installation environment of an apparatus or characteristics of each part.

However, heretofore, without considering the installation environment and characteristics of parts, the warning has been carried out only by judgment whether or not an accumulated amount of work reached a reference value. For example, in the image forming apparatus of Japanese Patent Application Publication No. H08-63053, the warning is carried out only by judgment whether or not an amount of operation of a photosensitive drum reached a predetermined number of life cycles, and the warning considering circumstances such as the above cannot be carried out.

The present invention was achieved with the above circumstances as the background, and it is an object of the invention to provide an image forming apparatus which can carry out a warning in response to installation environment of an apparatus or characteristics of each part, when a warning that a part used in the apparatus has reached its end of life is carried out.

### SUMMARY

1. To achieve at least one of the above mentioned objects, an image forming apparatus reflecting one aspect of the present invention comprises a plurality of replaceable parts and a control section which manages an accumulated amount of work of each of the parts; wherein the control section comprises reference values for replacement of each of the parts and performs a first mode which carries out a prescribed control in case when an accumulated amount of work of any one of parts of the plurality of parts reaches one of the reference values for replacement; and, a second mode which carries out the prescribed control in case when an accumulated amount of work of a specific part of the plurality of parts reaches one of the reference values for replacement.
2. In the abovementioned image forming apparatus of item 1, wherein the control section performs an operation to switch between the first mode and the second mode.
3. In the abovementioned image forming apparatus of item 1 further comprises a memory section which memorizes the accumulated amount of work of each of the parts and the reference values for replacement, wherein the control section reads out and compares the accumulated amount of work of each of the parts and the reference values for replacement, and judges whether or not the accumulated amount of work of each of the parts reaches the reference values for replacement.
4. In the abovementioned image forming apparatus of item 1, wherein the control section sets the reference value corresponding to each of the modes.
5. In the abovementioned image forming apparatus of item 1, wherein the control section makes a warning as the prescribed control in the first or second modes.
6. In the abovementioned image forming apparatus of item 5, further comprises an operation display section which provides a user with a setting operation and a display, wherein the control section makes the prescribed warning display on the operation display section.
7. In the abovementioned image forming apparatus of item 6, wherein the control section performs the setting whether each of the parts is only for the first mode, or for both the first and second modes.
8. In the abovementioned image forming apparatus of item 7, wherein the control section performs the setting by operation inputs at the operation display section.
9. In the abovementioned image forming apparatus of item 5, further comprises a communication section which connects to a network, and the control section notifies the warning through the communication section connected to the network.
10. In the abovementioned image forming apparatus of item 9, wherein the control section notifies the warning to a service side.
11. In the abovementioned image forming apparatus of item 10, wherein the control section notifies the warning to the service side by e-mails or a remote diagnosis system for the image forming apparatus.

12. In the abovementioned image forming apparatus of item 10, wherein the control section notifies the warning to the service side through the communication section, when, in the second mode, the accumulated amount of work of part which is not a target of the warning reached the reference value for replacement in the first mode.

### BRIEF DESCRIPTION OF THE DRAWINGS

FIG. 1 is a block diagram showing a structure of the image forming apparatus of an embodiment of the present invention.

FIG. 2 is similarly a block diagram of control.

FIG. 3 is similarly an example of a screen of switching settings of warning display.

FIG. 4 is similarly a flow chart showing control steps when a warning display of parts replacement is carried out.

FIG. 5 is similarly a figure showing an example of screen of warning display.

FIG. 6 is similarly an example of screen of the present accumulated amount of work of each part at a selection of mode 1.

FIG. 7 is similarly an example of screen of the present accumulated amount of work of each part at a selection of mode 1.

FIG. 8 is similarly an example of screen of the present accumulated amount of work of each part at a selection of mode 2.

FIG. 9 is similarly a figure showing an example of structure of a remote management system.

FIG. 10 is similarly a figure showing an example of sending an e-mail.

FIG. 11 is similarly a flow chart showing control steps when a warning display of parts replacement is carried out in a remote management system.

FIG. 12 is similarly an example of screen in which reference values for replacement for each mode are set.

FIG. 13 is similarly an example of screen in which a mode of warning display for each part is set.

### DESCRIPTION OF THE PREFERRED EMBODIMENT

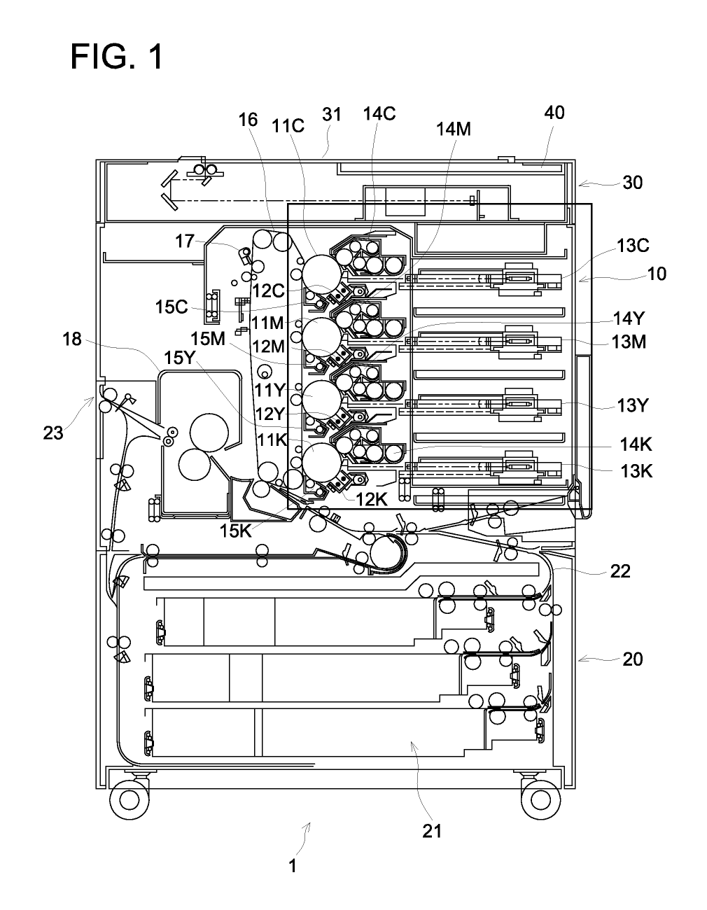

An embodiment of the present invention will be described below based on referenced drawings. FIG. 1 is a figure showing a mechanical structure of image forming apparatus 1 of the present invention, which will be described below.

In FIG. 1, numerals 10, 20, and 30 indicate respectively an image forming section, a sheet feeding section, and a document reading section.

At document reading section 30, an image of a document conveyed by an automatic document feeder (not illustrated), or of a document placed on platen 31 is read, and temporarily recorded in a non-illustrated image memory and the like.

Image forming section 10 comprises photoreceptors 11C, 11M, 11Y, and 11K, each of which was prepared for each color (cyan, magenta, yellow, black and the like), and there are arranged at peripheries of each of photoreceptors 11C, 11M, 11Y, and 11K, chargers 12C, 12M, 12Y, and 12K, writing sections 13C, 13M, 13Y, and 13K, and developing units 14C, 14M, 14Y, and 14K. On the surfaces of photoreceptors 11C, 11M, 11Y, and 11K charged by chargers 12C, 12M, 12Y, and 12K, images are exposed by writing sections 13C, 13M, 13Y, and 13K based on image information of a document recorded in an image memory and the like, and then, latent images are formed on the surfaces of photoreceptors 11C, 11M, 11Y, and 11K. The aforesaid latent images are developed by developing units 14C, 14M, 14Y, and 14K to toner images. The toner images are transferred to intermediate transfer belt 16, which images are then transferred to a sheet of paper conveyed from the aforesaid intermediate transfer belt 16 by sheet feeding section 20. The transferred sheet is heated and fixed by fixing unit 18, and then, an image forming output (a print) is achieved in a sheet discharge section.

Also at image forming section 10, in response to each photoreceptor, there are arranged cleaning sections 15C, 15M, 15Y, and 15K, which remove residual toner by contacting each of photoreceptors 11C, 11M, 11Y, and 11K, at the rotation direction side of contact points with intermediate transfer belt 16, and at the reverse side of the rotation direction of chargers 12C, 12M, 12Y, and 12K. Also, there is arranged cleaning section 17, which removes residual toner on the aforesaid intermediate transfer belt 16, at the rotation direction side of sheet transfer position of intermediate transfer belt 16, and at the reverse side of the rotation direction of transfer position of each photoreceptor.

In image forming apparatus 1, a plurality of sheet feed trays 21, . . . , and 21, in which sheets of paper are stored, are arranged at lower side of the above image forming section 10. Further, image forming apparatus 1 has conveyance path 22 which leads from each of sheet feed trays to image forming section 10, and further leads from image forming section 10 to sheet discharge section 23.

Each of above photoreceptors 11C, 11M, 11Y, and 11K is rotationally driven by a non-illustrated driving motor, and intermediate transfer belt 16 is also rotationally driven in the same way by a non-illustrated driving motor.

The above photoreceptors 11C, 11M, 11Y and 11K, writing sections 13C, 13M, 13Y and 13K, developing units 14C, 14M, 14Y and 14K, fixing unit 18, or the like may be deteriorated or may require replacement as a result of a repetition of image formation. Therefore, with regard to a plurality of parts which require replacement, at a control section which will be described later, an accumulated amount of work of each part is managed, and at the same time, by comparing this accumulated amount of work with the prescribed reference values for replacement, the control for parts replacement is carried out by appropriately switching between the first mode which performs the prescribed control when an accumulated amount of work of any one of the above plurality of parts reaches a reference value for replacement, and the second mode which performs the prescribed control when an accumulated amount of work of a specific part of the above plurality of parts reaches a reference value for replacement.

The accumulated amount of work can be shown by an accumulated number of printing on sheets, the number of hours worked, and the like, and different accumulated amount of work may be used for different parts.

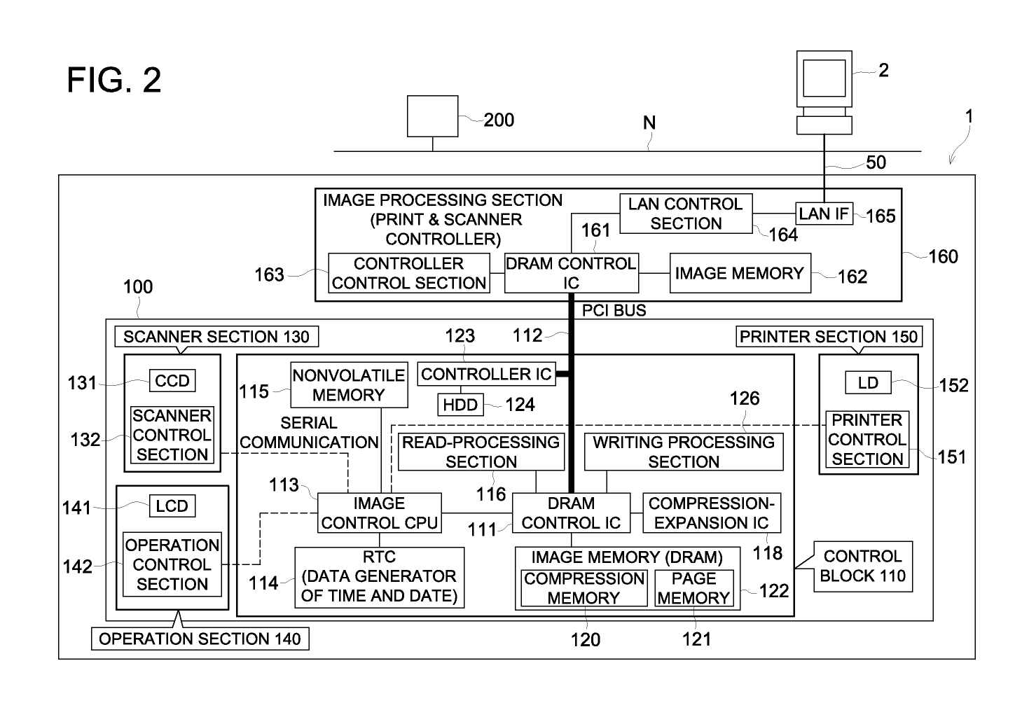

Next, FIG. 2 is a block diagram showing an electrical construction of the image forming apparatus of the present invention, which will be described below.

Image forming apparatus 1 is provided with copier body 100 comprising control block 110, scanner section 130, operation section 140, and image processing means (a print and scanner controller) 160 which processes image data which are subjected to input-output with external devices (for example terminal 2) through LAN 50. LAN 50 is connected with internet network N and thereby is connected with service center 200 so that communication is possible.

Control block 110 is connected with DRAM control IC 111 in control block 110. In addition, control block 110 is provided with image control CPU 113, and aforesaid image control CPU 113 is connected with the above DRAM control IC 111. Image control CPU 113 is connected with nonvolatile memory 115. In the aforesaid nonvolatile memory, there are stored an accumulated amount of work (hereinafter referred to as a life value) of replaceable parts used in the above image forming section 10 (for example, the above photoreceptors 11C, 11M, 11Y and 11K, developing units 14C, 14M, 14Y and 14K, and the like), and reference values for replacement of these parts (hereinafter referred to as a reference value for life), other than a program to get the above image control CPU 113 to work, and data such as setting data of image forming apparatus 1, and a process control parameter. Namely, the aforesaid nonvolatile memory 115 functions as a memory section of the present invention.

Image control CPU 113 controls the entire image forming apparatus 1, and grasps the entire situation of the image forming apparatus, and further, carries out management of an accumulated amount of work of each replaceable part in the apparatus and determination of the control mode relating to the parts replacement. Namely, image control CPU 113 functions as a control section of the present invention. Also, image control CPU 113 is connected with RTC 114 (a data generator of time and date) which measures the date and time using a driving source such as an internal cell or an external cell.

The above scanner section 130 is provided with CCD 131 which performs optical reading and scanner control section 132 which controls the entire scanner section 130. Scanner control section 132 is connected with the above image control CPU 113 so that serial communication is possible, and is controlled by image control CPU 113. Scanner control section 132 can be structured by a CPU, a program which gets the CPU to work, and the like. The image data which was read out at the above CCD 131 are sent from scanner control section 132 to the above image control CPU 113, and further sent to read-out processing section 116 via the above DRAM control IC 111, and then, data processing is performed at the aforesaid read-out processing section 116. Further, the above DRAM control IC 111 is connected with compression-expansion IC 118 which compresses or expands the image data read at the above CCD 131.

The above operation section 140 is provided with LCD 141 of a touch screen type and operation control section 142. The above LCD 141 is connected with operation control section 142, and the aforesaid operation control section 142 is connected with the above image control CPU 113 in such a manner that serial communication is possible. With the aforesaid structure, the control of operation section 140 is carried out by image control section 113. Operation control section 142 can be structured by a CPU and a program which gets the CPU to work, and the like. At operation section 140, it is possible to make the settings in the image forming apparatus 1 and to make inputs of work control conditions such as a work instruction, and it is further possible to display the contents of the settings, machine conditions, information, and the like, all of which are controlled by the above image control CPU 113. With this operation section 140, the switching operation between the above first mode and second mode, or a warning display on parts replacement can be carried out. Namely, the aforesaid operation section 140 functions as the operation display section of the present invention. In the meantime, in this embodiment, the operation display section is structured by the above touch screen, and thereby the display and the operation input are possible. However, as the present invention, the display section which carries out a display and the input section which carries out an input may be individually provided, and the operation display section may be constructed with these sections.

DRAM control IC 111 is connected with image memory 122 composed of compression memory 120 and page memory 121. In the aforesaid image memory, image data obtained at the above scanner section 130 or through LAN 50 are stored. As described above, image memory 122 is a memory area of the image data, and stores image data of jobs to be printed. Further, by the above DRAM control IC 111, the image data on a plurality of jobs can be memorized in image memory 122. Namely, the image data of reserved jobs can also be stored.

Furthermore, the above PCI bus 112 connected with DRAM control IC 111 is connected, through controller IC 123, with HDD 124 which stores image data, and the data in the above image memory 122 and the like are, if needed, stored in the above HDD 124.

Further, DRAM control IC 111 is connected with writing processing section 126. The aforesaid writing processing section 126 is connected, through the above DRAM control IC 111 and the above image control CPU 113, with printer control section 151 which controls the entire printer section 150, and carries out data processing used for actions of LD 152 of printer section 150 (corresponding to writing sections 13C, 13M, 13Y and 13K in FIG. 1). In printer section 150, the above image forming section 10, sheet feeding section 20, and the like are included, and the actions are controlled by image control CPU 113.

The above PCI bus 112, which is connected with the above DRAM control IC 111, is connected with DRAM control IC 161 of the above image processing means (a print and scanner controller). In image processing means (a print and scanner controller) 160, DRAM control IC 161 is connected with image memory 162. In addition, in the image processing means (a print and scanner controller), controller control section 163 is connected with the above DRAM control IC 161, and LAN interface 165 is further connected with DRAM control IC 161 through LAN control section 1264. LAN interface 165 is connected with the above LAN 50. Namely, LAN control section 164 and LAN interface 165 function as the communication section of the present invention.

LAN 50 is connected with service center 200 in such a manner that communication is possible, other than terminal 2 as was described above.

Next, basic actions of the above image forming apparatus 1 will be described.

First of all, steps to accumulate image data in image forming apparatus will be described. In the case when an image of document is read at scanner section 130 to generate image data, an image of document is optically read via CCD 131 from a document at scanner section 130. At this time, an action of CCD 131 is controlled by scanner control section 132 which receives an instruction from image control CPU 113. The image read by CCD 131 is subjected to data processing at read-out processing section 116, and the image data which was subjected to data processing are compressed by the prescribed method at compression-expansion IC 118 to be stored in compression memory 120 through DRAM control IC 111. The image data stored in compression memory 120 can be managed as a job by image control CPU 113.

In the case of obtaining image data from outside, for example image data sent from terminal 2 through LAN 50 are stored in image memory 162 by DRAM control IC 161 through LAN interface 165 and LAN control section 164. The data of image memory 162 are temporarily stored in page memory 121 through DRAM control IC 161, PCI bus 112, and DRAM control IC 111. The data stored in page memory 121 are successively sent to compression-expansion IC 118 though DRAM control IC 111 to be subjected to compression processing, which are then stored in compression memory 120 through DRAM control IC 111, and then managed by image control CPU 113 in the similar way to the above.

In the case of outputting an image by image forming apparatus 1, that is, in the case of using image forming apparatus 1 as a copier or a printer, the image data stored in compression memory 120 is sent to compression-expansion IC 118 though DRAM control IC 111 to expand the data, which expanded data are then sent to writing processing section 126, and then, writing to each of photoreceptors 11C, 11M, 11Y and 11K is carried out at LD 152.

At printer section 150, each section is controlled by printer control section 151 which received instructions of image control CPU 113. Namely, a sheet of paper determined by image control CPU 113 based on the weight of the sheet and the like is repeatedly supplied to image forming section 10 by sheet feeding section 20. At image forming section 10, a toner image which was wrote on each photoreceptor is transferred to intermediate transfer belt 16, after which the transferred toner image is transferred to a sheet of paper supplied by sheet feeding section 20, and then, fixed at fixing unit 18. The sheet on which an image was formed is conveyed to a post-processing apparatus (not illustrated) via a conveying section, and then, the post-processing is carried out in the case when the post-processing is instructed, or the sheet is discharged to a discharge tray without any further processing in the case when no post-processing is required. When there is a plurality of reserved jobs, the above image outputs are successively carried out according to a pre-arranged order.

At each of photoreceptors 11C, 11M, 11Y and 11K, toner images are transferred to intermediate transfer belt 16, after which the residual toner is removed by each of cleaning sections 15C, 15M, 15Y and 15K. Similarly, at intermediate transfer belt 16, the toner images are transferred to a sheet, after which the residual toner is removed by cleaning section 17.

In the above image forming apparatus 1, as the initial settings, it is set in advance to control in which mode of the above first mode (mode 1) and the above second mode (mode 2), and it is made possible for the user to change the setting. Here, assuming that a warning is made to the user regarding the reaching of the end of life as the prescribed control method in the above modes 1 and 2, an example, will be described, as its specific method, in which the prescribed warning is displayed on LCD 141 of the above operation section 140.

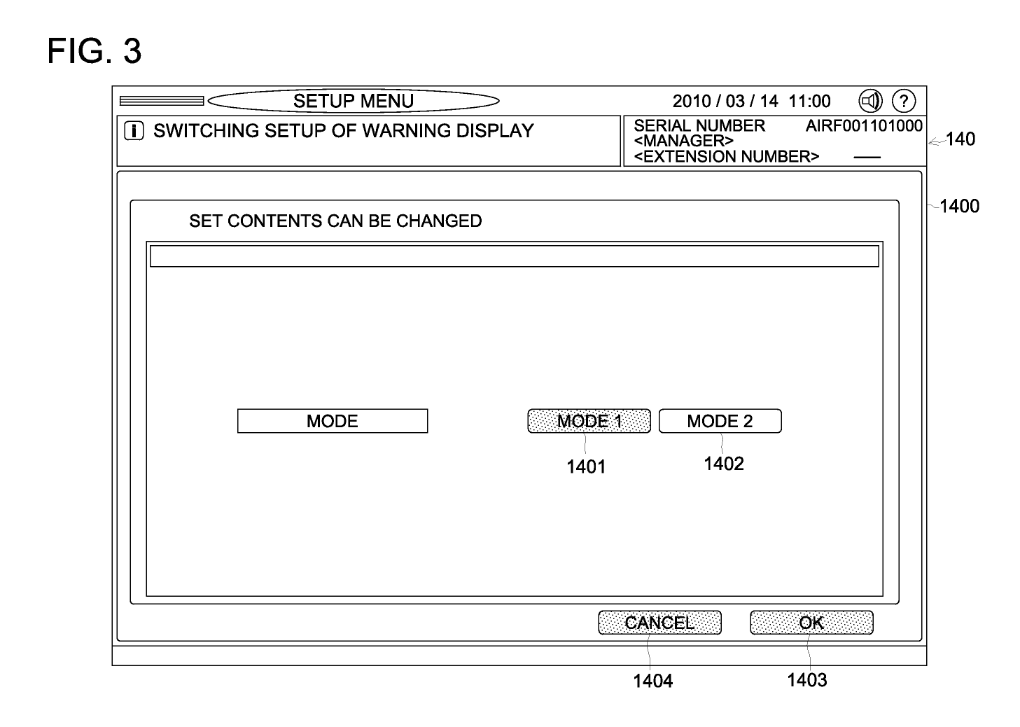

FIG. 3 shows an example of screen of switching setup of warning display 1400.

The user at first calls screen of switching setup of warning display 1400 from a menu screen (not illustrated) displayed on LCD 141 of the above operation section 140 and the like, and sets up with which mode a warning will be made. On screen of switching setup of warning display 1400, mode 1 button 1401 and mode 2 button 1402 are displayed in such a manner that pushing a button is possible, and further, OK button 1403 and cancel button 1404 are displayed in such a manner that pushing a button is possible. On this screen, the user can select a desired mode by pushing OK button 1403 after the user pushes mode 1 button 1401 or mode 2 button 1402, and can suitably switch the mode. The selection of the mode is fixed by pushing OK button 1403, and the selected mode is memorized in the above nonvolatile memory 115 and the like.

When cancel button 1404 is pushed, the selection input of the mode before OK button 1403 was pushed is cancelled, and the screen returns to the original state before the input.

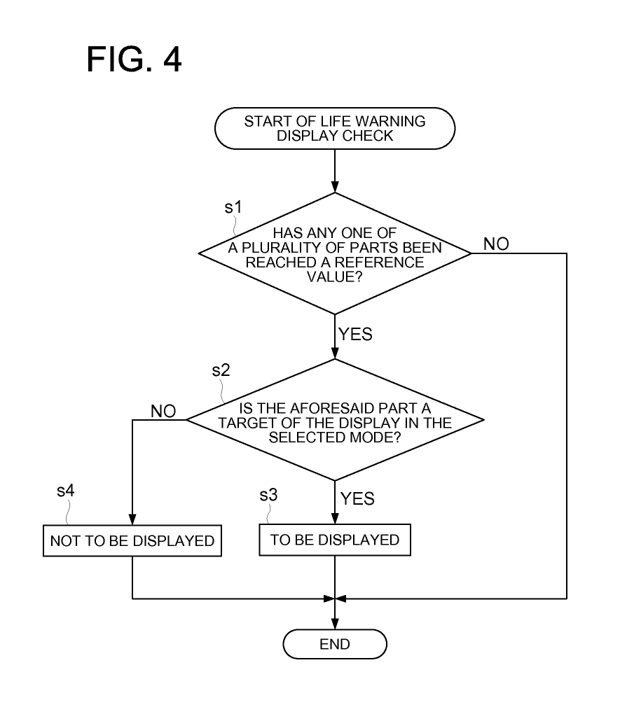

Next, control steps of the above image control CPU 113 in image forming apparatus 1 in which a mode was set as described above will be described based on the flow chart in FIG. 4.

First, the above image control CPU 113 reads out a life value and a life reference value of each part, and then, confirms whether or not the life value of any one of parts reaches the life reference value (step 1). In the case where no life value reaches the life reference value (step 1, NO), the processing is terminated without any further processing, since no particular reaction is needed.

On the other hand, in the case where the life value of any one of parts reaches the life reference value (step 1, YES), image control CPU 113 confirms whether or not the aforesaid part is a target of a warning display in the currently selected mode (mode 1 or mode 2) (step 2). If it is mode 1, a part for replacement can be a target of the warning display. If it is mode 2, YES or NO of the warning display differs for each part for replacement. The above image control CPU 113 confirms in this way that a part in which the life value has reached the life reference value is a target or not of a warning display in the currently selected mode, and in the case where it is a target of the warning display (step 2, YES), a warning on replacement of the aforesaid part is displayed on the above LCD 141, and then, the processing is terminated. On the other hand, in the case where it is not a target of the warning display (step 2, NO), the processing is terminated without carrying out the warning display on replacement of the aforesaid part.

A setting example which part should be made a target of a warning display in the currently selected mode will be described based on Table 1. Table 1 shows the name and the life value of each part, and, in each of modes 1 and 2, which part should be made a target of a warning display. In Table 1, “A” indicates that a warning display is carried out, and “B” indicates that no warning display is carried out

TABLE 1

| Name of Part | Mode 1 | Mode 2 | Life Value (%) |
|---|---|---|---|
| Photoreceptor Unit (yellow) | A | B | 0 |
| Photoreceptor Unit (cyan) | A | B | 0 |
| Photoreceptor Unit (magenta) | A | B | 0 |
| Photoreceptor Unit (black) | A | B | 0 |
| Developer Unit (yellow) | A | B | 0 |
| Developer Unit (cyan) | A | B | 0 |
| Developer Unit (magenta) | A | B | 0 |
| Developer Unit (black) | A | B | 0 |
| Transfer Belt Cleaning Unit | A | B | 0 |
| Charging Unit (yellow) | A | B | 0 |
| Charging Unit (cyan) | A | B | 0 |
| Charging Unit (magenta) | A | B | 0 |
| Charging Unit (black) | A | B | 120 |
| Toner Filter | A | A | 0 |
| Developing Unit (yellow) | A | B | 0 |
| Developing Unit (cyan) | A | B | 0 |
| Developing Unit (magenta) | A | B | 115 |
| Developing Unit (black) | A | B | 147 |
| Secondary Transfer Cleaning Blade | A | B | 0 |
| Ozone Filter | A | B | 0 |
| Fixing Web | A | A | 0 |

For example, when a life reference value is set to “100%” with respect to the prescribed life, since the “charging unit (black)” (corresponding to charger 12K of FIG. 1) has a life value of “120%” and already reached a life reference value, in the case where mode 1 has been selected, a warning display is carried out based on “A” setting. On the other hand, in the case where mode 2 has been selected, even if the “charging unit (black)” has reached a life reference value, a warning display is not carried out based on “B” setting.

According to Table 1, since every part is set to be “A” in mode 1, when a life value of any one of parts reaches the life reference value, a warning display is carries out. Therefore, in such installation environment where a high quality is demanded to image quality of a document or the like which is an output of image formation, it is desirable that a warning display by mode 1 is carried out.

On the other hand, in such installation environment where very high image quality of a document or the like which is an output of image formation is not essential, a selection can be made so that a warning display by mode 1 is not carried out. Namely, in consideration of installation environment and the like of the apparatus, with regard to parts which can be continuously used over their lives, unnecessary warnings on these parts can be avoided by making them fall outside of the warning display in mode 2. Furthermore, in the case where a life value went over a reference value and reached the prescribed value, the above prescribed value may be separately set so that a warning is carried out.

For parts in which the setting is set to be “A” to carry out a warning display in mode 2, a different reference value for making a warning from the reference value in the above mode 1 may be set.

In either mode 1 or mode 2, the parts which are a target of the warning display are, for example, desirably assigned to be the parts which cannot be functionally used over their lives. In Table 1, the “toner filter” and “fixing web” (both figures are omitted) are a target of the warning display. The “toner filter” is used for the purpose of preventing toner scattering and capturing the toner. If the toner filter is continuously used over its life, the filter is clogged, and if the filter is further used in the clogged state, the toner is scattered as a result leading to contamination of the inside of the apparatus.

The “fixing web” is a roll-shaped part for wiping off fixing stains which was adhered to a fixing roller of the above fixing unit 18, and, if the roll paper runs out, no further stains can be wiped off. As such, the parts which cannot be functionally used over their lives are desirably made a target of the warning display in modes 1 and 2.

The settings of parts being a target of the warning display in each mode shown in Table 1 are carried out in advance by the user, and at the same time, are intended to be memorized in the above nonvolatile memory 115 or the like.

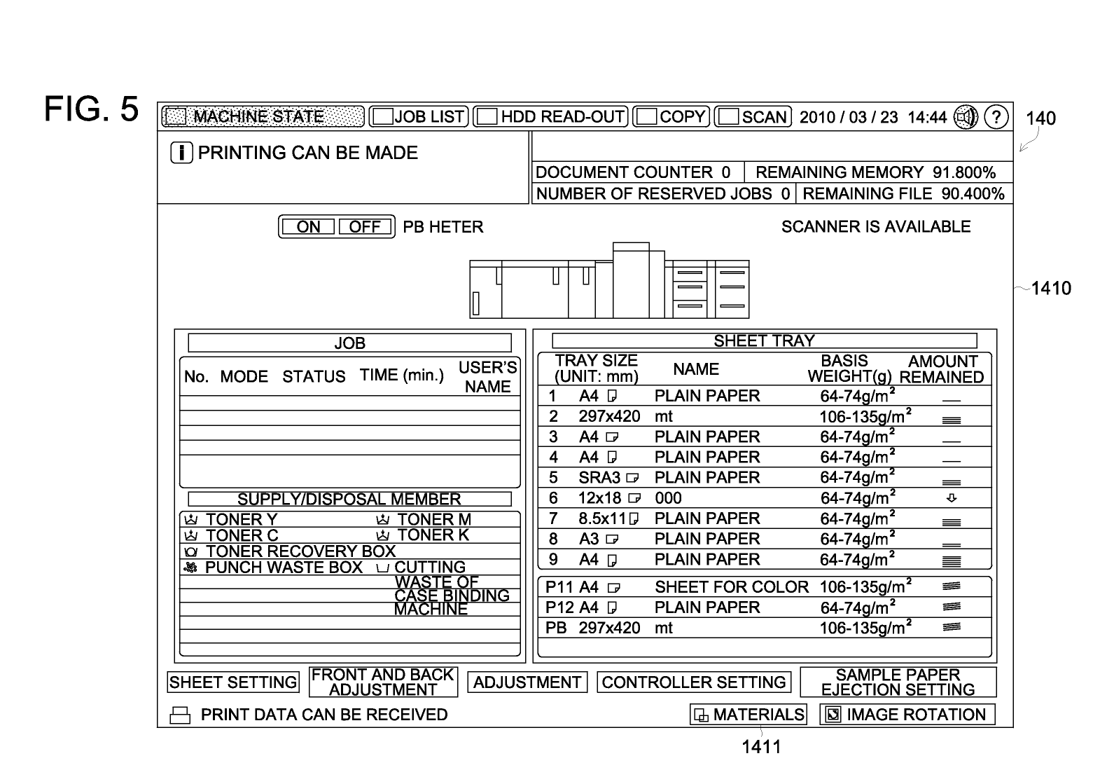

Next, an example of screen of warning display is shown in FIG. 5. The aforesaid screen shows display of machine state 1410, and, as a warning display, materials button 1411 is shown at the lower right part of the above display of machine state 1410. The user can confirm the detailed information of the content of warning by pushing down this materials button 1411 to call a screen (the figure is omitted) displaying the details of the content of warning. The example of the screen of the warning display shown in FIG. 5 is not limited to this, and any embodiments may be accepted as long as the display can inform of arrival of a reference value of a part to the user.

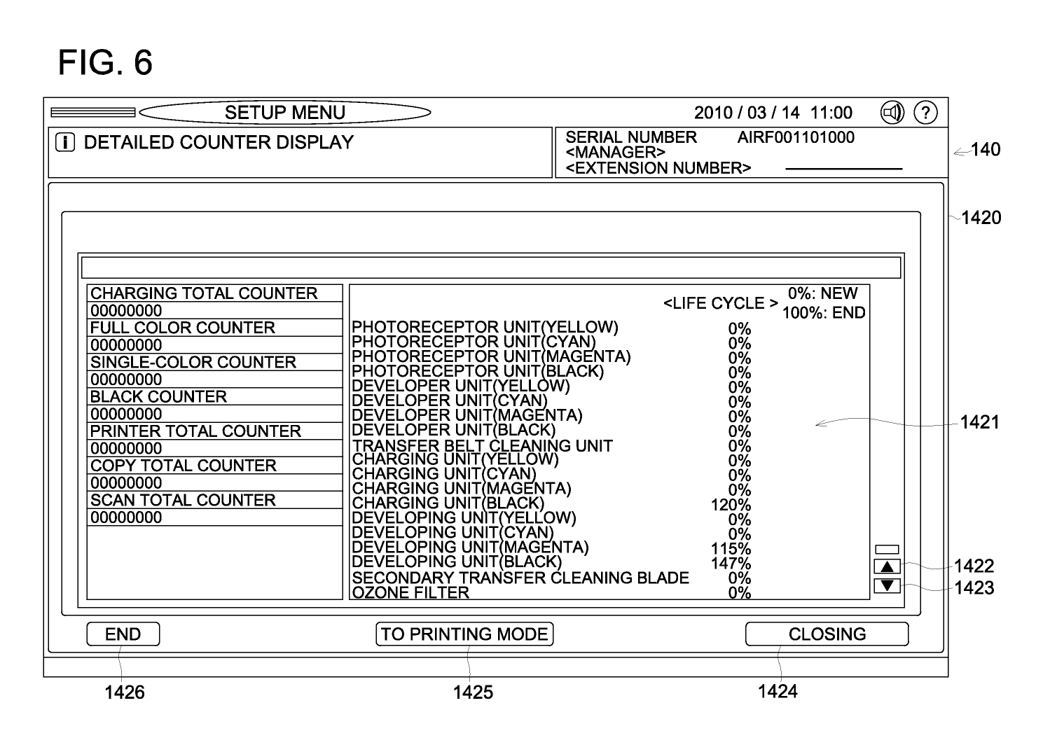

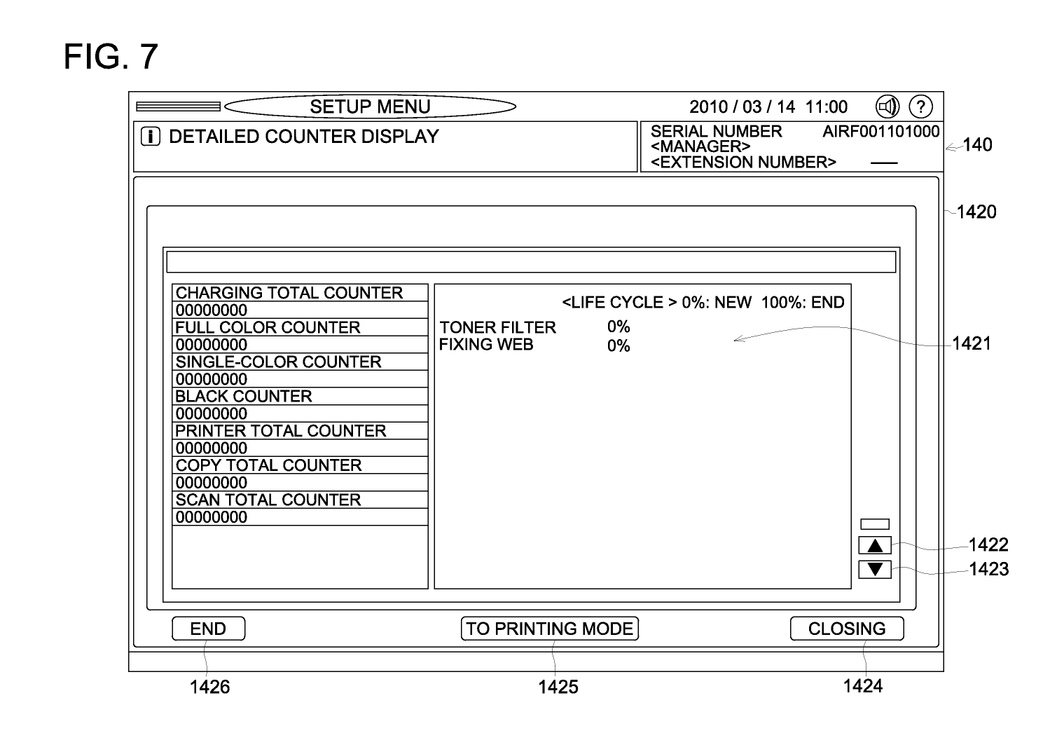

At this time, it may be made so that a screen of warning display shown in FIG. 5 is transferred to life value display screen 1420 which displays the current life value of each part. FIGS. 6 and 7 are an example of the screen showing the current life value of each part. Since, in mode 1, every part is a target of the warning display as shown in Table 1, the current life value of every part is displayed over two screens. Namely, life value display column 1421 is displayed on life value display screen 1420, and a life value of each part is shown (on the screen, it is displayed as a life cycle). Life value display column 1421 is displayed over two pages as this form, and the page can be changed by pushing previous button 1422 or next page button 1423. In FIG. 7, life value display screen 1420 is shown in which life value display column 1421 on page 2 is displayed by pushing next page button 1423. By pushing previous page button 1422 at the state of this screen, life value display screen 1420 shown in FIG. 6 is displayed.

By pushing closing button 1424, the screen displaying the details is closed to go back to the warning display screen. By pushing printing mode button 1425, the screen is transferred to a setting screen regarding a printing mode. By pushing end button 1426, the screen regarding the warning display is closed to return to the upper screen of the warning display screen.

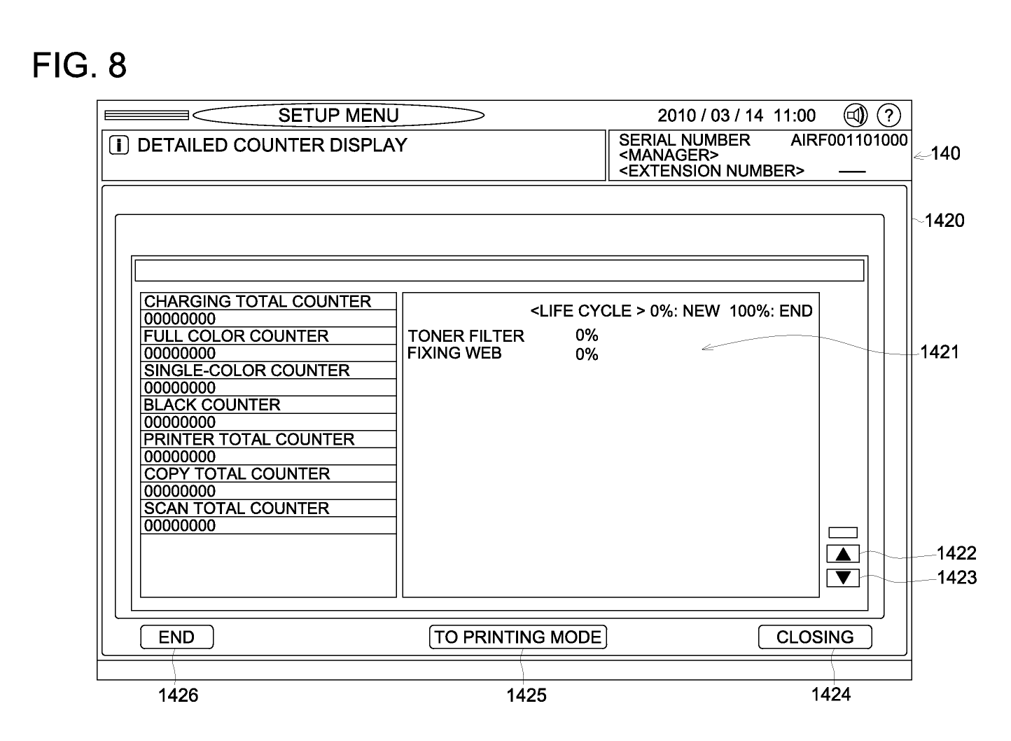

On the other hand, FIG. 8 shows life value display screen 1420, which displays the current life value of each part, in the case where mode 2 is selected. In mode 2, since only a toner filter and a fixing web are a target of the warning display, the life values of these parts are displayed at the above life value display column 1421. The other display structure is similar to those shown in FIGS. 6 and 7.

As described above, the above image forming apparatus 1 is provided with mode 1 in which the warning display is carried out in the case where the life value of any one of a plurality of parts used in the apparatus reaches the life reference value and mode 2 in which the warning display is carried out in the case where the life value of a specific one of the above plurality of parts reaches the life reference value, and then, by switching these modes, it becomes possible for the above image forming apparatus 1 to carry out the warning display in response to installation environment of the apparatus, characteristics of each part, or user's demands.

In particular, by selecting mode 2 which gives a warning only when a specific part reaches a reference value, troublesomeness that unnecessary warning continues on a part which the user wants to use continuously is solved, and at the same time, an unnecessary parts replacement is avoided to reduce downtime, and labor and parts costs.

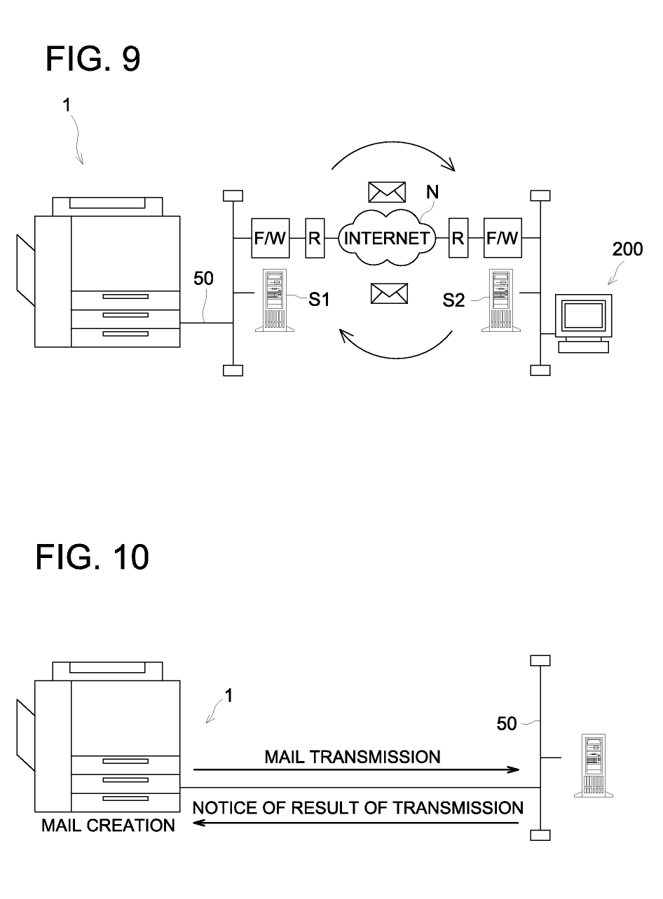

Next, a structure will be described based on FIGS. 9 to 11 in which the above image forming apparatus 1 is connected in such a manner that communication is possible with a service side which controls the operation situation of the apparatus through network 50. In such a structure, image forming apparatus 1 and the above service side construct a remote management system of image forming apparatus 1 by transmission and reception of various data by utilizing an e-mail or the like.

Here, as an example of the remote management system, there will be described an example which uses the remote management system, a maintenance service which manages the state of an image forming apparatus by remote control. Further, here, an example in which the above service side is service center 200 will be described, but, the service side may be a service person such as a customer engineer.

FIG. 9 shows an example of structure of a remote management system. Image forming apparatus 1 is connected in such a manner that communication is possible with service center 200 which controls the operation situation of the apparatus through firewall F/W, router R, and internet network N. Image forming apparatus 1 is connected with internet network N through LAN 50, and the network according to the present invention is constructed by LAN 50 and internet network N. Image forming apparatus 1 and service center 200 are connected in such a manner that communication is possible with mail server S1 and mail server S2, respectively, and, with these connections, it is configured that mutual transmission and reception of e-mails is possible.

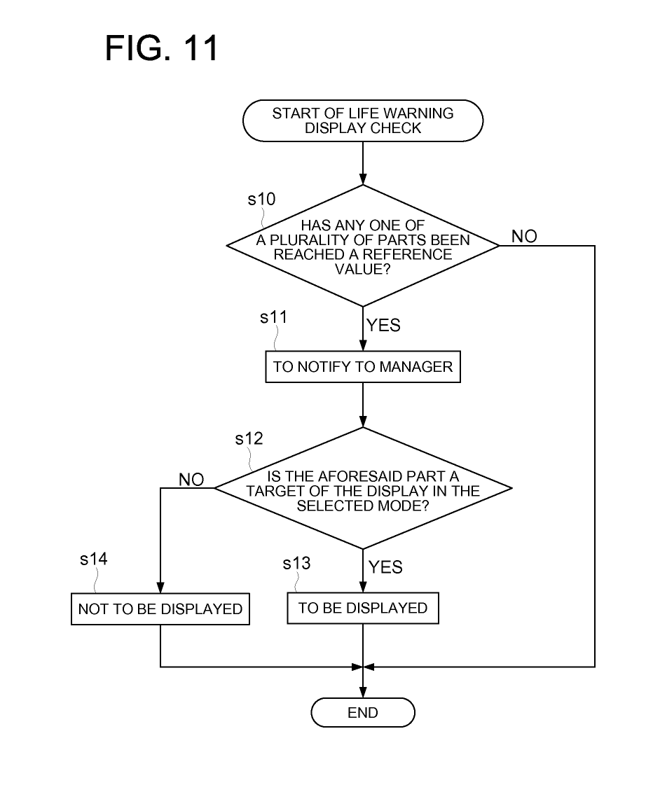

An example of transmission of e-mails is shown in FIG. 10. When an event of mail transmission, such as a hindrance and parts replacement occurs, image forming apparatus 1 creates an e-mail based on the aforesaid event, which mail is then transmitted to the above mail server S1 through internet network N. Mail server S1 transmits the received e-mail to mail server S2 through internet network N, and, at the same time, sends back a notice of result of the transmission to image forming apparatus 1 at the time of completion of the transmission of the message. On the other hand, service center 200 can grasp the operation situation including parts replacement of image forming apparatus 1 by receiving an e-mail from mail server S2. Hereinbelow, control steps of the above image control CPU 113 in the above structure will be described based on the flowchart of FIG. 11.

First, the above image control CPU 113 reads out a life value and a life reference value of each part from the above nonvolatile memory 115, and confirms whether or not a life value of any one of parts reaches the life reference value (step s10). As a result, in the case where no life value reaches the life reference value (step s10, NO), the processing is terminated without a further processing, since no particular reaction is needed.

On the other hand, in the case where the life value of any one of parts reaches the life reference value (step s10, YES), image control CPU 113 creates an e-mail notifying that a life value of the aforesaid part reached the life reference value, and transfers it to the above LAN control section 164. LAN control section 164 transmits the transferred e-mail to the above mail server S1 through the above LAN IF 165 and LAN 50. Mail server S1 transmits the received e-mail to mail server S2 via internet network N, and then, service center 200 receives the e-mail from mail server S2. In this way, image forming apparatus 1 notifies service center 200 that the life value of the part reached the life reference value (step 11).

When the notice to service center 200 is completed, image control CPU 113 confirms based on the above Table 1 whether or not the part which was notified to have reached the reference value at step s11 is a target of the warning display in the mode having been currently selected (step s12).

As a result, in the case of having been a target of the warning display (step s12, YES), image control CPU 113 displays a warning regarding the replacement of the aforesaid part on LCD 141 of the above operation display section 140 (step a13). On the other hand, in the case of not having been a target of the warning display (step s12, NO), the processing is terminated without displaying a warning regarding the replacement of the aforesaid part (step s14).

As described above, in image forming apparatus of the above structure, in the case where the life value of any part reaches the life reference value, a notice that the aforesaid part reached the reference value is sent to the service center via the network independing on the selected mode of the warning display. After the notice to the service center, a decision is made where or not the warning display that the aforesaid part reached the reference value is carried out based on the settings in the above Table 1. Namely, implementation of the warning display is carried out according to the currently selected mode.

In this way, according to the above structure, the operation situation including information on parts replacement of image forming apparatus 1 can be easily managed at service center 200 side, and thereby it becomes possible to take a prompt action in response to the situation. In particular, in mode 2, since a notice that not only a part which is a target of the warning display of parts replacement, but also a part which is not a target of the warning display has reached the reference value is sent to service center 200, there can be reduced a possibility of an event that a part in which no warning display is carried out has reached the reference value is forgotten.

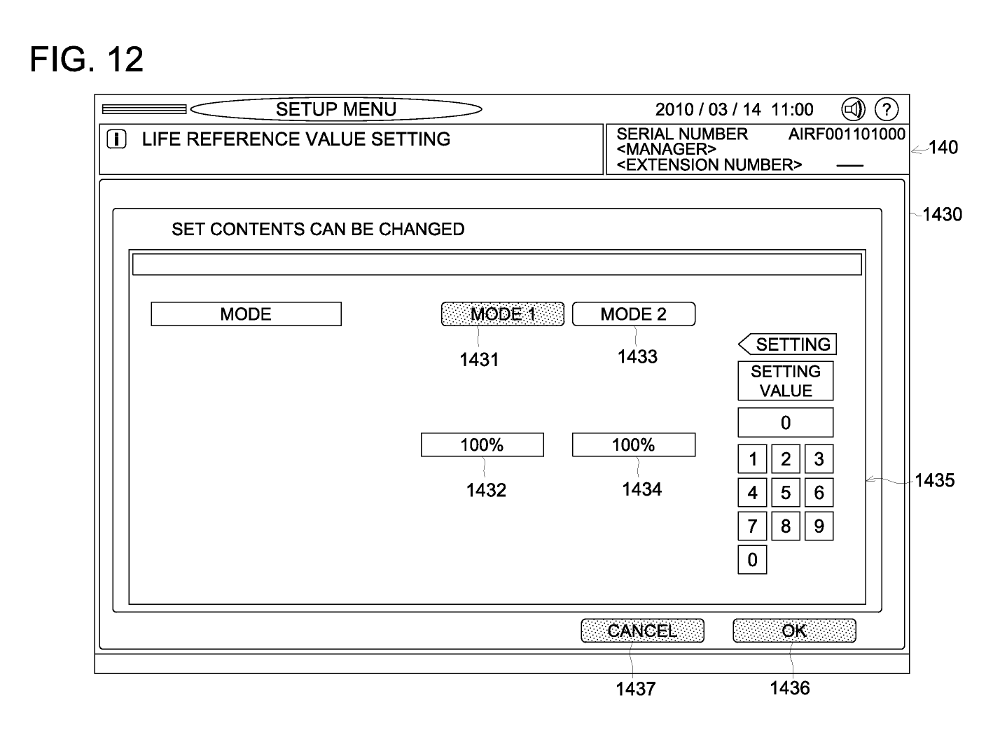

Next, FIG. 12 shows an example of life reference value setting screen for each mode 1430 in which the life reference value which becomes a reference of parts replacement is set for each mode of the warning display, and the aforesaid screen is displayed on LCD 141 of operation display section 1430 in such a manner that operation is possible.

In operation display section 1430, in the upper part thereof, mode 1 selection button 1431 and mode 2 selection button 1433 are displayed in such a manner that the button can be pushed, and in the lower part of each of the buttons, mode 1 reference display column 1432 and mode 2 reference display column 1434 each of which displays the predetermined life reference value.

In the right side of life reference value setting screen for each mode 1430, numeric keypad 1435 is displayed in such a manner that operation input is practicable. In addition, in the lower side of life reference value setting screen for each mode 1430, OK button 1436 and cancel button 1437 are displayed in such a manner that the button can be pushed.

The user at first pushes either mode 1 selection button 1431 or mode 2 selection button 1432, which are displayed in the upper side of life reference value setting screen for each mode 1430, and then, inputs a desired life reference value using numeric keypad 1435. The life reference value having been input is displayed in mode 1 reference display column 1432 or mode 2 reference display column 1434. By pushing OK button 1436, the setting value is fixed, and the aforesaid setting value is memorized in the above nonvolatile memory 115 or the like. After inputting the life reference value, if the cancel button is pushed without pushing OK button 1436, the value having been input is cancelled, and the life reference value is returned to the original one.

In the case where the reference value is set for each mode, it may be made so that the reference value can be input with mode 1 with the reference value of mode 2 being fixed to, for example, 100%. In this case, if, for example, the life reference value of mode 2 is preferably fixed to “100%”, the setting of the life reference value may be permitted with the selection button of mode 2 not being allowed to push, and with only the selection button of mode 1 being allowed to push.

In this way, the user can appropriately set a desired life reference value for each mode to optionally adjust a replacement standard, and thereby, warning displays responding to different demands for each user such as installation environment of an apparatus can be carried out. The example of a screen of the life reference value setting shown in FIG. 12 is not limited to this, and any embodiments may be accepted as long as the life reference value can be set for each mode.

In this example, different life reference values for each mode is made possible to be set, but it may be accepted that no reference setting for each mode can be carried out by using the same reference value for both mode 1 and mode 2.

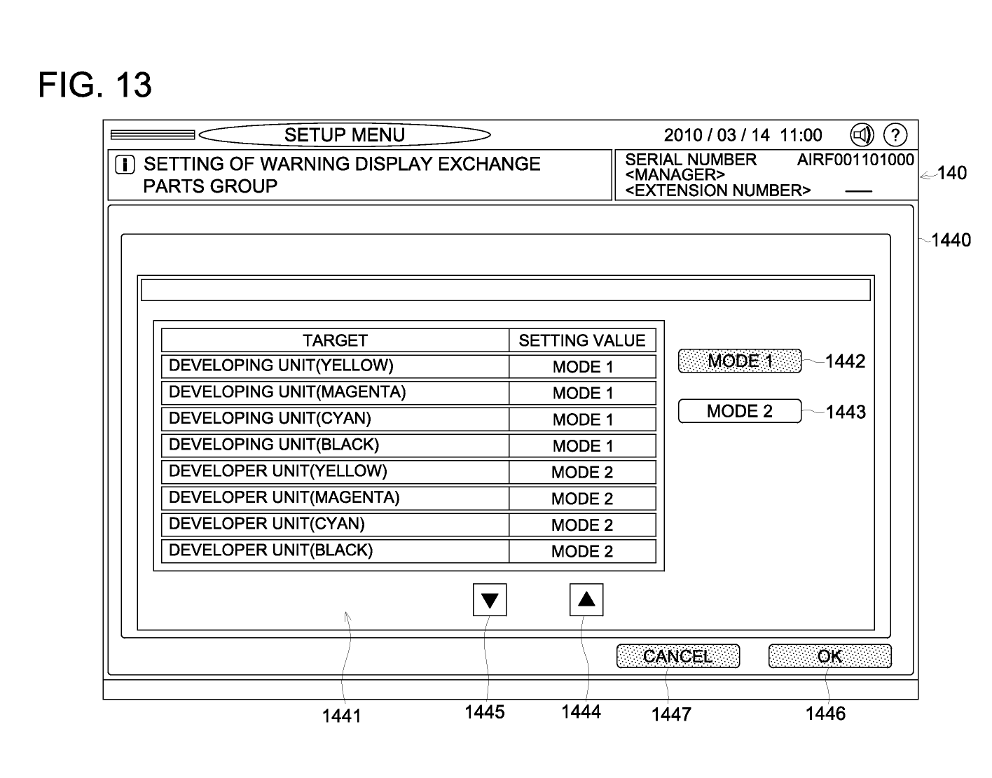

Next, FIG. 13 shows an example of parts group setting screen 1440, which sets whether a part becomes a target of the display of the above mode 1 or a target of the display of both the above mode 1 and mode 2 for each part.

In the left side of parts group setting screen 1440, parts group display column 1441 showing a mode for each part is displayed in such a manner that operation is possible, and, in the right side, mode 1 selection button 1442 and mode 2 selection button 1443 for mode selection are displayed so that pushing a button is possible. In the lower part of parts group display column 1441, scroll up button 1444 and scroll down button 1445 are displayed in such a manner that the button can be pushed. In the lower part of parts group setting screen 1440, OK button 1446, and cancel button 1447 are displayed in such a manner that the button can be pushed.

The user at first pushes scroll up button 1444 or scroll down button 1445 to select a part for which the user wants to set a mode. Next, the user pushes mode 1 selection button 1442 or mode 2 selection button 1443 to select a desired mode. The mode having been input is applied to the part selected in the above, and displayed in the above parts group display column 1441.

With this, information on a target part of the display of each mode stored in the above nonvolatile memory 115 is renewed. In this example, as shown in FIG. 13, setting values of “developer unit (yellow)”, “developer unit (magenta)”, “developer unit (cyan)”, and “developer unit (black)” are changed to “mode 2”. The settings of target parts of the warning display of each mode are shown in Table 2.

TABLE 2

| Name of Part | Mode 1 | Mode 2 |
|---|---|---|
| Photoreceptor Unit (yellow) | A | B |
| Photoreceptor Unit (cyan) | A | B |
| Photoreceptor Unit (magenta) | A | B |
| Photoreceptor Unit (black) | A | B |
| Developer Unit (yellow) | A | A |
| Developer Unit (cyan) | A | A |
| Developer Unit (magenta) | A | A |
| Developer Unit (black) | A | A |
| Transfer Belt Cleaning Unit | A | B |
| Charging Unit (yellow) | A | B |
| Charging Unit (cyan) | A | B |
| Charging Unit (magenta) | A | B |
| Charging Unit (black) | A | B |
| Toner Filter | A | A |
| Developing Unit (yellow) | A | B |
| Developing Unit (cyan) | A | B |
| Developing Unit (magenta) | A | B |
| Developing Unit (black) | A | B |
| Secondary Transfer Cleaning Blade | A | B |
| Ozone Filter | A | B |
| Fixing Web | A | A |

In Table 2, as described above, on the four parts in which the settings of the warning display were changed to “mode 2”, “A” is set indicating a target of the warning display in mode 1 and mode 2. The toner filter and the fixing web have been classified into the presence of “warning display of mode 2” before the above settings.

In this way, since the user can appropriately set, for each part, whether a part becomes a target of the display of mode 1 or a target of the display of both mode 1 and mode 2, the warning displays responding to different demands for each user such as installation environment of an apparatus can be carried out. The example of setting screen shown in FIG. 13 is not limited to this, and any embodiments may be accepted as long as the mode setting for each part is possible.

In the above description, the present invention was described based on the above embodiment, but the present invention is not limited to the content of the above embodiment, and appropriate changes can naturally be made as long as the changes do not depart from the scope of the present invention.

For example, in the present description, examples of displaying a warning screen were consistently described, but the warning method is not limited to this, and any embodiments may be accepted as long as the method can notify the user that a part reached the reference value, such as, for example, a method for generating a warning sound or a warning signal.

As described above, according to the image forming apparatus of the present embodiment, the image forming apparatus is provided with a plurality of replaceable parts and a control section which manages an accumulated amount of work of each of the above parts, and the aforesaid control section has reference values for replacement of each of the above parts, and comprises the first mode carrying out the prescribed control in the case where the accumulated amount of work of any one of parts of the above plurality of parts reaches the above reference values for replacement, and the second mode carrying out the prescribed control in the case when the accumulated amount of work of a specific part of the above plurality of parts reaches the above reference values for replacement, and therefore, it becomes possible to carry out controls for parts replacement in response to installation environment of an apparatus, characteristics of each part, or user's demands.

In particular, by being provided with the second mode carrying out the prescribed control in the case where the accumulated amount of work of a specific part reaches the above reference values for replacement, a part which the user wants to use continuously can be made outside of the control, and thereby, an unnecessary parts replacement is avoided, and at the same time, downtime, and labor and parts costs can be reduced.

Namely, embodiment of the image forming apparatus of the present invention including a plurality of replaceable parts and a control section which manages an accumulated amount of work of each of the parts; wherein the control section comprises reference values for replacement of each of the parts and performs a first mode which carries out a prescribed control in case where an accumulated amount of work of any one of parts of the plurality of parts reaches one of the reference values for replacement; and, a second mode which carries out the prescribed control in case where an accumulated amount of work of a specific part of the plurality of parts reaches one of the reference values for replacement.

According to the above embodiment, since the image forming apparatus includes different control modes between the case where, among a plurality of replaceable parts used in an image forming apparatus, the accumulated amount of work of any one of parts reaches the reference values for replacement and the case where the accumulated amount of work of a specific part, it becomes possible to carry out controls for parts replacement in response to installation environment of an apparatus, characteristics of each part, or user's demands.

As for another embodiment, the control section performs an operation to switch between the first mode and the second mode.

According to the above embodiment, the user can appropriately switch between the first mode and the second mode, and, for a part desired by the user, a control such as a warning can be achieved, and further, a warning and the like can be achieved at different times desired by the user for the first mode and the second mode.

As for another embodiment, the image forming apparatus includes a memory section which memorizes the accumulated amount of work of each of the parts and the reference values for replacement, wherein the control section reads out and compares the accumulated amount of work of each of the parts and the reference values for replacement, and judges whether or not the accumulated amount of work of each of the parts reaches the reference values for replacement.

According to the above embodiment, a memory section such as nonvolatile flash memory and HDD which memorized the accumulated amount of work of each of the parts and reference values for replacement can be utilized.

As for another embodiment, the control section sets the reference value corresponding to each of the modes.

According to the above embodiment, the user can set up each reference value for replacement which differs from the first mode to the second mode, and then, can carry out a control to meet installation environment of an apparatus or user's demands.

As for another embodiment, the control section makes a warning as the prescribed control in the first or second modes.

According to the above embodiment, the user recognizes a warning on parts replacement to take an appropriate action.

As for another embodiment, image forming apparatus includes an operation display section which provides a user with a setting operation and a display, wherein the control section makes the prescribed warning display on the operation display section.

According to the above embodiment, since there is provided with the operation display section on which the prescribed warning is displayed, the user can easily grasp the content of the warning.

As for another embodiment, the control section performs the setting whether each of the parts is only for the first mode, or for both the first and second modes.

According to the above embodiment, the user can optionally set whether each of the parts is for the first mode, or for both the first and second modes, and then, can carry out a warning to meet characteristics of each part.

As for another embodiment, the control section performs the setting by operation inputs at the operation display section.

According to the above embodiment, the user can, through the operation display section, easily set whether each of the parts is for the first mode, or for both the first and second modes. The setting may be made as an initial setting, and in this case, the setting can be changed through the operation display section.

As for another embodiment, the image forming apparatus includes a communication section which connects to a network, and the control section notifies the warning through the communication section connected to the network.

According to the above embodiment, a warning can be made to a terminal, a user server, or the like, which is connected to an image forming apparatus with a network.

As for another embodiment, the control section notifies the warning to a service side.

According to the above embodiment, at the service side which controls an operational situation of an image forming apparatus, the content of warning on parts replacement can be easily grasped, and thereby a prompt action can be taken. The aforesaid warning may be made together with a warning to the user, or may be singly made only to the service side.

The service side includes a service center where management and the like of service persons or maintenance are carried out in one place.

As for another embodiment, the control section notifies the warning to the service side by e-mails or a remote diagnosis system for the image forming apparatus.

According to the above embodiment, when the content of warning on parts replacement is notified to the service side, e-mails or a remote diagnosis system of an image forming apparatus can be utilized without restriction of distance or time.

As for another embodiment, the control section notifies the warning to the service side through the communication section, when, in the second mode, the accumulated amount of work of part which is not a target of the warning reached the reference value for replacement in the first mode.

According to the above embodiment, when, in the second mode, an accumulated amount of work of part which is not a target of the warning reached the reference value of replacement in the first mode, the content of warning and the like of the aforesaid part is notified to the service side, and therefore, it is possible to avoid a possibility that both the user and the service side may forget that a part to which a warning is not given in the second mode reached a reference value for replacement.

What is claimed is:

1. An image forming apparatus comprising a plurality of replaceable parts and a control section which manages an accumulated amount of work of each of the parts;
wherein the control section comprises reference values for replacement of each of the parts and performs a first mode which carries out a prescribed control in case when an accumulated amount of work of any one of parts of the plurality of parts reaches one of the reference values for replacement; and,
a second mode which carries out the prescribed control in case when an accumulated amount of work of a specific part of the plurality of parts reaches one of the reference values for replacement.

2. The image forming apparatus of claim 1, wherein the control section performs an operation to switch between the first mode and the second mode.

3. The image forming apparatus of claim 1 further comprises a memory section which memorizes the accumulated amount of work of each of the parts and the reference values for replacement,
wherein the control section reads out and compares the accumulated amount of work of each of the parts and the reference values for replacement, and judges whether or not the accumulated amount of work of each of the parts reaches the reference values for replacement.

4. The image forming apparatus of claim 1, wherein the control section sets the reference value corresponding to each of the modes.

5. The image forming apparatus of claim 1, wherein the control section makes a warning as the prescribed control in the first or second modes.

6. The image forming apparatus of claim 5, further comprises an operation display section which provides a user with a setting operation and a display,
wherein the control section makes the prescribed warning display on the operation display section.

7. The image forming apparatus of claim 6, wherein the control section performs the setting whether each of the parts is only for the first mode, or for both the first and second modes.

8. The image forming apparatus of claim 7, wherein the control section performs the setting by operation inputs at the operation display section.

9. The image forming apparatus of claim 5, further comprises a communication section which connects to a network, and the control section notifies the warning through the communication section connected to the network.

10. The image forming apparatus of claim 9, wherein the control section notifies the warning to a service side.

11. The image forming apparatus of claim 10, wherein the control section notifies the warning to the service side by e-mails or a remote diagnosis system for the image forming apparatus.

12. The image forming apparatus of claim 10, wherein the control section notifies the warning to the service side through the communication section, when, in the second mode, the accumulated amount of work of part which is not a target of the warning reached the reference value for replacement in the first mode.

13. A management method of an image forming apparatus comprising:
managing an accumulated amount of work of each of the parts which is relating to a plurality of replaceable parts of the image forming apparatus;
performing a first mode which carries out a prescribed control in case where an accumulated amount of work of any one of parts of the plurality of parts reaches one of the reference values for replacement; and,
performing a second mode which carries out the prescribed control in a case where an accumulated amount of work of a specific part of the plurality of parts reaches one of the reference values for replacement.

14. The management method of claim 13, comprising performing an operation to switch between the first mode and the second mode.

15. The management method of claim 13, comprising:
memorizing the accumulated amount of work of each of the parts and the reference values for replacement;
reading out and the accumulated amount of work of each of the parts and the reference values for replacement;
comparing the read out accumulated amount of work of each of the parts and the reference values for replacement; and
judging whether or not the accumulated amount of work of each of the parts reaches the reference values for replacement.

16. The management method of claim 13, comprising setting the reference value corresponding to each of the modes.

17. The management method of claim 13, comprising making a warning as the prescribed control in the first or second modes.

18. The management method of claim 17, wherein in the step of making the warning, the prescribed warning is displayed on the operation display section which provides a user with a setting operation and a display.

19. The management method of claim 18, comprising performing the setting whether each of the parts is only for the first mode, or for both the first and second modes.

20. The management method of claim 19, wherein the setting is performed by operation inputs at the operation display section.

21. The management method of claim 17, comprising notifying the warning through the communication section connected to the network.

22. The management method of claim 21, wherein the warning is notified to a service side.

23. The management method of claim 21, wherein the warning is notified to the service side by e-mails or a remote diagnosis system for the image forming apparatus.

24. The management method of claim 22, wherein the warning is notified to the service side through the communication section, when, in the second mode, the accumulated amount of work of part which is not a target of the warning reached the reference value for replacement in the first mode.
